(19) United States
(12) Patent Application Publication
(10) Pub. No.: US 2012/0174666 A1
(43) Pub. Date: Jul. 12, 2012

(54) WATER LEVEL MEASURING METHOD AND DEVICE

(75) Inventor: Rutger Robert Godfried Gast, Almere (NL)

(73) Assignee: F. RUIJTENBERG HOLDING B.V., MC Ede (NL)

(21) Appl. No.: 13/389,022

(22) PCT Filed: Aug. 7, 2009
(86) PCT No.: PCT/NL2009/050485

§ 371 Date: Mar. 16, 2012

(51) Int. Cl. G01F 23/14

(52) U.S. Cl. 73/299

(57) ABSTRACT

It is described a method and a device for measuring the water level in a water storage tank by means of a pressure measuring device comprising a pressure gauge, a pressurising bulb and a tubing. The pressure measuring device is provided in an enclosure and the tubing comprises an inner tubing coupling the pressure gauge and the pressurising bulb inside the enclosure, and an outer tubing having one end which is branched from the inner tubing and exits the enclosure. The other outer tubing end while joined to a dead weight is advantageously capable of being conveyed through an overflow or aerating tank piping to the bottom of the water storage tank. The enclosure protects the device against mechanical damage, dust and dirt, as well as moisture and light. This is particularly important in rural areas where life- and environmental circumstances leave much to be desired.

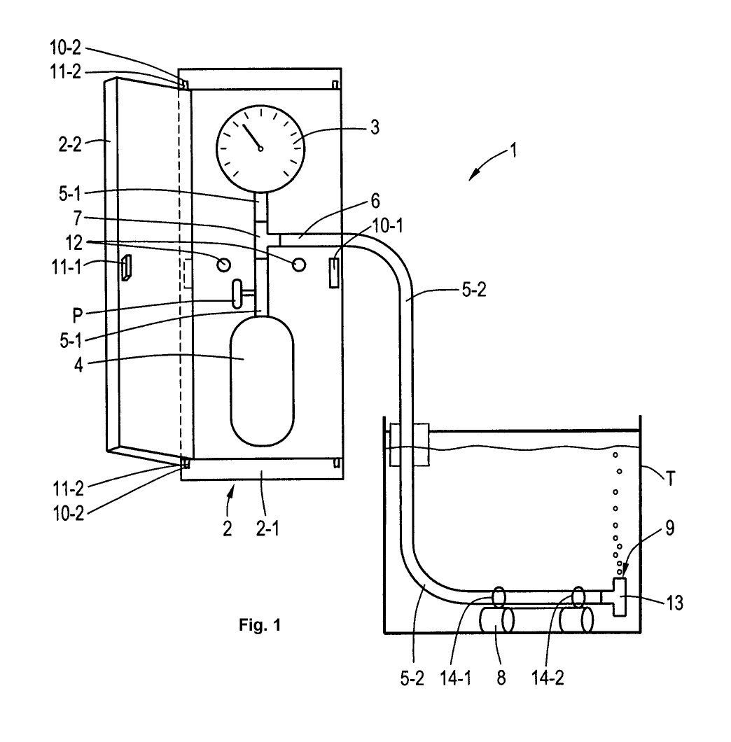

The present invention relates to a method of measuring the water level in a water storage tank by means of a pressure measuring device comprising: a pressure gauge, a pressurising bulb and a tubing.

The present invention also relates to a pressure measuring device for measuring the water level in a water storage tank, and to the use of such a device.

Such a device is generally known and is being used to measure the water level in water storage tanks which are to be filled with rainwater or water, supplied by trucks or tank cars. Such water tanks are commonly known in rural areas. The water level is measured by pressurising by means of a bulb the tubing between a gauge and the bottom of the water tank. The maximum achievable pressure is a measure for the actual water level in the tank and can be read from the gauge.

The known device is vulnerable for mechanical damage, and comprises the gauge and bulb as loose components connected by some plastic tubing which can buckle easily which may then cause unreliable readings. Such readings are furthermore unreliable if the end of the tubing is not located near the bottom of the water tank.

It is an object of the present invention to provide an improved method and pressure measuring device whose measuring results are more reliable.

Thereto the method according to the invention is characterised in that the pressure measuring device is provided in an enclosure and that the tubing comprises an inner tubing coupling the pressure gauge and the pressurising bulb inside the enclosure, and an outer tubing having one end which is branched from the inner tubing and exits the enclosure, whose other outer tubing end while joined to a dead weight is capable of being conveyed through an overflow or aerating tank piping to the bottom of the water storage tank.

Accordingly the pressure measuring device according to the invention is characterised in that the device comprises an enclosure including a pressure gauge, a pressurising bulb and an inner tubing coupling the pressure gauge and the pressurising bulb, an outer tubing having one end which is branched from the inner tubing and exits the enclosure, and a dead weight, whereby the outer tubing has an other outer end which while joined to the dead weight is capable of being conveyed through an overflow or aerating tank piping to the bottom of the water storage tank.

It is an advantage of the method and device according to the present invention that an enclosure is provided which includes, shields and protects the pressurising bulb and pressure gauge for measuring the water level in the tank, against mechanical damage, dust and dirt. In addition it has been found that the pressure gauge needs adequate protection against water and moisture because for which it appeared very vulnerable. The flexible pressurising bulb appeared very vulnerable against light, in particular UV light in order to guarantee a long crack-free life span, and he enclosure also provides good protection against sunlight. The aforementioned advantageous properties are also important in rural areas and in particular under tropical conditions where the life- and environmental circumstances leave much to be desired.

The enclosure can at wish be stored or for example be hung on the wall in order to permanently secure incidental, but reliable use.

In addition a combination of the dead weight joined with the outer tubing end is presented having a specific overall size such that the combination may advantageously be slipped through existing orifices, such as an overflow outlet at the side or an aerating piping normally available at the top of such tanks. The weight is such that the combination will sink to the bottom of the tank and will also stay at the bottom, such that a fixed colon of water above the weight and the tubing end allow long time measurements to provide accurate pressure measuring results, which reflect the amount of water that is available in the tank.

The device according to the invention is easy to manufacture for a low cost-price, easy to mount and install, does not require any electric connection, is practically maintenance free and is manually operable.

At present the method and pressure measuring device according to the invention will be elucidated further together with their additional advantages, while reference is being made to the appended sole FIGURE, which shows an outline of possible embodiments of the method and device according to the present invention.

The figure shows a pressure measuring device 1 for measuring the water level in a water storage tank T such as generally used in rural areas in absence of wide scale water supply systems. The device 1 can be applied in for example dwellings. The device 1 comprises a casing or enclosure 2 which may be a two part closable enclosure, one enclosure part thereof is embodied by a support 2-1 which comprises a pressure gauge 3, a pressurising bulb 4 and a tubing 5 provided with an inner tubing 5-1 connecting the pressure gauge 3 and the manually operable flexible pressurising bulb 4. The other enclosure part embodies a lid 2-2 that may be clamped suitably onto the support 2-1.

The device 1 also has the tubing 5 provided with an outer tubing 5-2 having one outer tubing end 6 which is branched here by some T-piece 7 from the inner tubing 5-1. The outer tubing 5-2 as shown exits the enclosure 2 through the side or possibly through the bottom of the enclosure 2. In the latter case the piece 7 may be embodied by a plus (+) shaped piece, not shown, in which case the inner tubing runs around the bulb 4 and their inner lower ends join in a T-piece such that the outer tubing 5-2 then exits through the bottom of the enclosure 2. If the inner tubing 5-1 is routed through the enclosure, while being held with possible friction between double walls of the enclosure 2, this results in a solid construction and in an effective relief of force if accidentally such force is applied to the outer tubing 5-2.

The enclosure 2 may at wish be provided with a bottom plate (not shown), which may be a detachable bottom plate, such that the pressurising bulb 4 does not protrude through the bottom of the enclosure 2 if this would be open.

The device 1 further comprises a dead weight 8, which is joined with another outer end 9 of the outer tubing 5-2. This joined of 8 and 9 can be easily slipped through a normally available overflow outlet or aerating tank piping and sunk to the bottom of the water storage tank T.

The method of measuring the water level in the tank T which is known per se involves after closing a pressure relieve valve P on the inner tubing 5-1, a manual pressurisation by means of squeezing the pressurising bulb 4 a number of times, possibly while the bulb hangs in the enclosure 2. Water is then pressed out of the outer tubing 5-2, until bubbles rise from the outer tubing end 9 near the weight 8. After stopping the squeezing and allowing the device 1 time to stabilise a stabile reading results on the gauge 3 which is calibrated to and commensurate with the water level in the tank T.

In the embodiment as shown in the figure the support 2-1 is provided with symmetrically provided closure 10-1 and/or pivoting means 10-2 for joining with corresponding means 11-1, 11-2 provided on the lid 2-2 for allowing the lid to be clamped in said closure and/or pivoting means 10-1, 10-2, such that possibly snap-wise closing or pivoting of the lid 2-2 can be effected. Alternatively a pivoting of the lid 2-2 can be effected in a left hand or a right hand fashion.

The support 2-1 may be provided with means, such as holes 12 for attaching it to a wall by means of screws, not shown in the figure.

Preferably as shown in the figure the dead weight 8 has an elongated form, which protects the submerged outer tubing end 9 joined therewith. The tubing end 9 may have a branched opening or as shown a possible T-piece 13 which prevents that end 9 from getting clogged with dirt or residue normally present at the bottom of the tank.

In an embodiment the dead weight 8 is provided with means 14, as shown in the form of eyes 14-1, 14-2 positioned to some distance relative to one another for damage protection by holding the outer tubing end 9 alongside the weight 8. Prior to inserting and slipping the joined combination of weight 8 and outer tubing end 9 through the orifice concerned, the tubing end 9 can be shifted and clamped through both eyes 14-1 and 14-2. In an alternative arrangement a piece branched at its open end, like for example a plus shaped piece, mentioned earlier, may be positioned in between the eyes 14-1 and 14-2. This effectively holds the open end 9 of the tubing 5-2 stabile between these eyes, which also results in more accurate readings.

Preferably the dead weight 8 is coated with a plastic for preventing pollution of water in the water storage tank T by dead weight material, and accordingly the two eyes are moulded integrally with the plastic coating.

The plastic is preferably white, as this reflects heat from the outer surface of the enclosure, thus keeping the gauge 3 and bulb 4 as cool as possible. On its ends the pivotable curved lid 2-2 has sides faces additionally preventing light from entering the enclosure 2.

1. Method of measuring the water level in a water storage tank by means of a pressure measuring device comprising a pressure gauge, a pressurising bulb and a tubing, characterised in that the pressure measuring device is provided in an enclosure and that the tubing comprises an inner tubing coupling the pressure gauge and the pressurising bulb inside the enclosure, and an outer tubing having one end which is branched from the inner tubing and exits the enclosure, whose other outer tubing end while joined to a dead weight is capable of being conveyed through an overflow or aerating tank piping to the bottom of the water storage tank.

2. Method according to claim 1, characterised in that the method of measuring the water level in the water storage tank, in particular the pressurising of the pressurising bulb, is effected while the pressure measuring device is within the enclosure.

3. Method according to claim 1 or 2, characterised in that the enclosure is a closable enclosure in particular having a pivotable lid.

4. A pressure measuring device for measuring the water level in a water storage tank, characterised in that the device comprises:
an enclosure including a pressure gauge, a pressurising bulb and an inner tubing coupling the pressure gauge and the pressurising bulb,
an outer tubing having one end which is branched from the inner tubing and exits the enclosure, and
a dead weight, whereby the outer tubing has an other outer end which while joined to the dead weight is capable of being conveyed through an overflow or aerating tank piping to the bottom of the water storage tank.

5. The device according to claim 4, characterised in that the enclosure is a two part closable enclosure, one enclosure part embodying a support for holding the pressure gauge, the pressurising bulb and the inner tubing, and the other enclosure part embodying a lid of the support.

6. The device according to claim 5, characterised in that the support is provided with symmetrically provided closure and/or pivoting means for joining with corresponding means provided on the lid for allowing the lid to be clamped in said closure and/or pivoting means such that closing or opening of the lid can be effected alternatively in one or the opposite pivoting direction.

7. The device according to claim 5 or 6, characterised in that the support is provided with means for attaching the support to the wall.

8. The device according to any one of the claims 4-7, characterised in that the pressurising bulb is provided with a pressure release valve.

9. The device according to any one of the claims 4-8, characterised in that the dead weight has an elongated form.

10. The device according to any one of the claims 4-9, characterised in that the dead weight is provided with means for holding the outer tubing end alongside the weight.

11. The device according to any one of the claims 4-10, characterised in that the outer tubing end is provided with a branched opening, possibly having a plus shaped piece or a T-piece for preventing the clogging of said end.

12. The device according to any one of the claims 4-11, characterised in that the dead weight is provided with two distant eyes where through the outer tubing end extends while being clamped therein.

13. The device according to any one of the claims 4-12, characterised in that the dead weight is coated with a plastic for preventing pollution of water in the water storage tank by dead weight material.

14. The device according to claims 12 and 13, characterised in that the two eyes are moulded in the plastic coating.

15. Use of the device according to any one of the claims 4-14 in applying the method according to any one of the claims 1-3 in water tanks for dwellings or for commercial use.
